(19) United States
(12) Patent Application Publication
(10) Pub. No.: US 2006/0040558 A1
(43) Pub. Date: Feb. 23, 2006

(54) Board mounted memory card connector with EMI shield

(76) Inventor: Yi-Tse Ho, Tainan Hsien (TW)

Correspondence Address: MOLEX INCORPORATED, 2222 WELLINGTON COURT, LISLE, IL, 60532, US

(21) Appl. No.: 11/205,500

(22) Filed: Aug. 17, 2005

(30) Foreign Application Priority Data
Aug. 17, 2004 (TW) 93213113

(51) Int. Cl. H01R 13/648

(52) U.S. Cl. 439/607

(57) ABSTRACT

A memory card connector is provided for mounting on a printed circuit board. The connector includes an insulative housing having a rear terminal-mounting section and which, at least in part, defines a card-receiving space. A plurality of conductive signal terminals and at least one ground terminal are mounted on the rear section of the housing. The terminals are electrically connected to the printed circuit board and include contact portions for engaging appropriate contacts on the memory card when the card is inserted into the housing. A ground shield cover is mounted on the housing at the rear thereof for shielding at least major portions of the signal terminals. The ground shield cover is conductively coupled between the ground terminal and the printed circuit board.

### FIELD OF THE INVENTION

This invention generally relates to the art of electrical connectors and, particularly, to a memory card connector for mounting on a printed circuit board and which has a ground shield cover over the termination area of the connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smart phones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. With circuit board mounted connectors, the terminals of a connector include tail portions which are connected to appropriate circuit traces on the printed circuit board by various systems, such as surface mount technology wherein the tail portions are reflow soldered to the circuit traces, or through hole technology wherein the tail portions of the terminals are inserted into holes in the printed circuit board for connection, as by soldering, to circuit traces on the board and/or in the holes.

FIG. 1 shows a board mounted memory card connector, generally designated 14, according to the prior art. The connector includes an insulative housing, generally designated 16; a shielding metal cover, generally designated 18; and a ground shield cover, generally designated 20. Housing 16 and metal cover 18 define a card-receiving space, generally designated 22, for insertion thereinto of a memory card in the direction of arrow “A”. A plurality of terminals, generally designated 24, are mounted in a rear termination area of the housing. The terminals include signal terminals and ground terminals and protrude from the housing for connection, as by soldering, to appropriate signal and ground circuit traces on the printed circuit board. The terminals have contact portions 24a for engaging appropriate contacts on the memory card. An eject mechanism 26 is used to eject the card from space 22. Metal cover 18 provides protection over the space against electromagnetic interference (EMI).

Ground shield cover 20 is fabricated of metal material and includes a cover portion 20a and a pair of ground portions 20b. The cover portion covers terminals 24, and the ground portions depend from opposite ends of the cover portion and are electrically connected, as by soldering, to appropriate ground pads on the circuit board. Cover portion 20a usually has a plurality of fingers 20c to cover contact portions 24a of the terminals and provide EMI protection for the contact portions and the terminals. With the grounded, board-mounted memory card connector 14 of FIG. 1, cover portion 20a and fingers 20c of ground shield cover 20 are electrically connected to the printed circuit board solely through ground portions 20b. Because of its high resistance, EMI protection is not as effective as is desired. The present invention is directed to providing such a memory card connector with a ground shield cover having improved grounding capabilities.

### SUMMARY OF THE INVENTION

An object, therefore, of the invention is to provide a memory card connector of the character described, with improved EMI protection.

In the exemplary embodiment of the invention, a memory card connector is provided for mounting on a printed circuit board. The connector includes an insulative housing having a rear terminal-mounting section and which, at least in part, defines a card-receiving space. A plurality of conductive signal terminals and at least one ground terminal are mounted on the rear section of the housing. The terminals are electrically connected to the printed circuit board and include contact portions for engaging appropriate contacts on the memory card when the card is inserted into the housing. A ground shield cover is mounted on the housing near the rear thereof for shielding at least major portions of the signal terminals. The ground shield cover is conductively coupled between the ground terminal and the printed circuit board.

According to one aspect of the invention, the ground shield cover includes an elongated plate portion extending along the rear terminal-mounting section of the housing over the signal terminals. Grounding leg portions depend from the plate portion into engagement with the ground pads on the printed circuit board. A plurality of fingers project from the plate portion over the contact portions of the signal terminals.

According to another aspect of the invention, a pair of the ground terminals are disposed at opposite ends of an array of the signal terminals. The ground shield cover is conductively coupled between the two ground terminals and the printed circuit board.

Other features of the invention include a metal cover mounted across a top of the insulative housing over a substantial portion of the card-receiving space. In one embodiment of the invention, a plurality of adapter terminals are electrically connected between the signal and ground terminals and the printed circuit board. The housing is sized such that the card-receiving space includes first and second card-receiving slots for receiving a pair of stacked memory cards. The plate portion of the ground shield cover extends over all of the signal terminals for both cards, and the fingers of the ground shield cover extend over the contact portions of the terminals for the top memory card.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a memory card connector according to the prior art and as described in the Background, above, with the ground shield cover removed from the housing;

FIG. 2 is a top perspective view of a memory card connector according to one embodiment of the invention, mounted on a printed circuit board and with the ground shield cover removed from the housing;

FIG. 3 is a bottom perspective view of the depiction in FIG. 2;

FIG. 4 is a view similar to that of FIG. 2, with the ground shield cover mounted on the housing;

FIG. 5 is a vertical section taken generally along line 5-5 in FIG. 4;

FIG. 6 is a perspective view of a modified version of the ground shield cover of the embodiment of FIGS. 2-5;

FIG. 7 is a bottom perspective view of a multi-part ground shield cover of a second embodiment of the invention;

FIG. 8 is a top perspective view of the ground shield cover of FIG. 7;

FIG. 9 is a fragmented perspective view of the connection area between the terminals and the printed circuit board according to a third embodiment of the invention;

FIG. 10 is an exploded perspective view of a memory card connector according to a fourth embodiment of the invention;

FIG. 11 is a view similar to that of FIG. 9, but of the fourth embodiment according to FIG. 10; and

FIG. 12 is a view similar to that of FIGS. 9 and 11, but of a fifth embodiment of the invention.

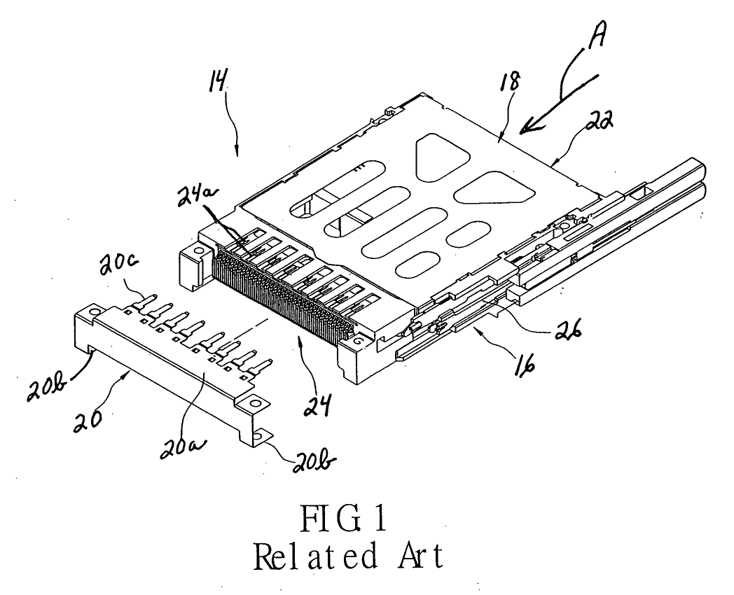

### DETAILED DESCRIPTION OF THE PREFERRED EMBODIMENTS

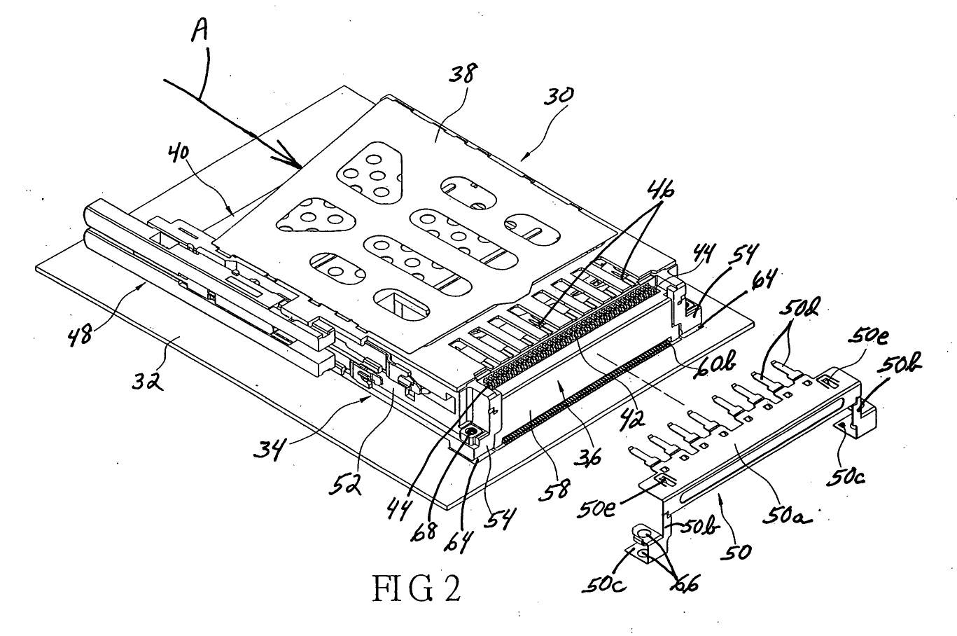

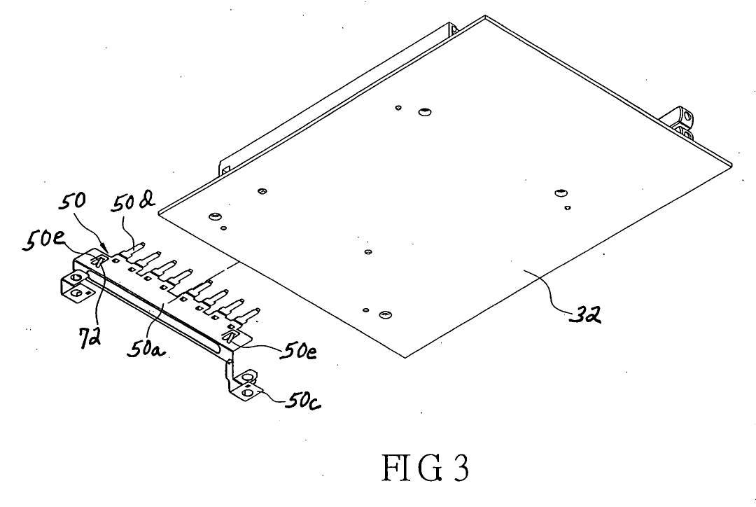

Referring to the drawings in greater detail, and first to FIGS. 2-4, the invention is embodied in a memory card connector, generally designated 30, for mounting on a printed circuit board 32. Generally, the connector includes an insulative housing, generally designated 34, which has a rear connector portion, generally designated 36, which defines a rear terminal-mounting section of the housing. A metal cover 38 is mounted across the top of the insulative housing and combines therewith to define a card-receiving space, generally designated 40, for the insertion thereinto of a memory card in the direction of arrow “A”. A linear array of signal terminals 42 are mounted across the rear of the housing, and a pair of ground terminals 44 are mounted at opposite ends of the array of signal terminals. The terminals have contacts portion 46 which project forwardly into the card-receiving space for engaging appropriate contacts on the memory card. An eject mechanism, generally designated 48, is mounted at one side of the housing. Finally, a ground shield cover, generally designated 50, is mounted at the rear of the housing to provide EMI protection at the rear termination area of the connector, i.e., the contact and termination area of signal terminals 42.

More particularly, housing 34 combines with connector portion 36 to define a generally U-shaped structure having side walls 52. Connector portion 36 is mounted between the rear ends of the side walls, and the side walls include integral mounting blocks 54 at the bottom rear corners of the connector. In the embodiments of the invention shown in the drawings, the card-receiving space 40 is sized for receiving two stacked memory cards and includes an upper card slot and a lower card slot. However, it should be understood that the card-receiving space may be sized to provide only one card slot for receiving a single memory card within the concepts of the invention. The housing, including connector portion 36, may be molded of dielectric material such as plastic or the like. Connector portion 36 has a plurality of terminal grooves (not numbered in the drawings) for mounting signal terminals 42 and ground terminals 44.

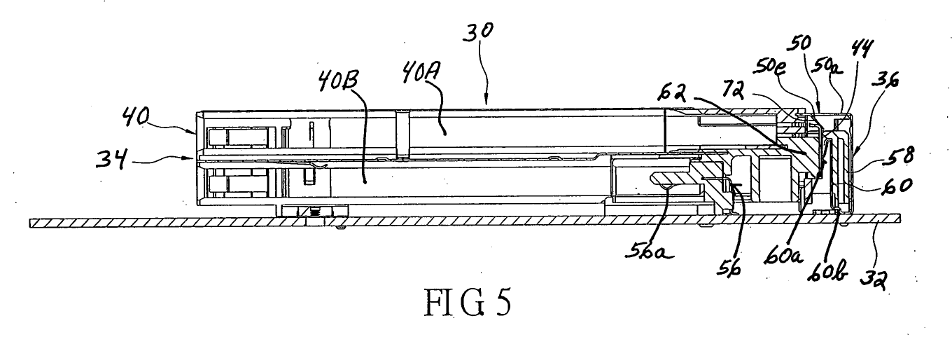

Referring to FIG. 5 in conjunction with FIGS. 2-4, it can be seen that the card-receiving space 40 includes an upper card slot 40A and a lower card slot 40B. A plurality of signal terminals, generally designated 56, are mounted within the connector and include contact portions 56a which are exposed within the lower card slot for engaging appropriate contacts on a memory card inserted into the lower slot. Being within the interior of the connector, these terminals are not that susceptible to external electromagnetic interference.

FIG. 5 shows that connector portion 36 includes a dielectric body 58 which mounts a plurality of adapter terminals 60. These adapter terminals have contact portions 60a which engage signal terminals 42 and ground terminals 44. The adapter terminals include tail portions 60b for connection, as by soldering, to appropriate circuit traces on printed circuit board 32. Therefore, the adapter terminals are effective to electrically connect the signal terminals and the ground terminals of the connector to printed circuit board 32. However, it will be seen hereinafter that the signal terminals and the ground terminals can extend all the way down for direct electrical connection to the printed circuit board. In the two-slot card-receiving space 40, signal terminals 42 and ground terminals 44 are provided for electrical connection to appropriate contacts on the memory card which is inserted into the upper card slot 40A of card-receiving space 40.

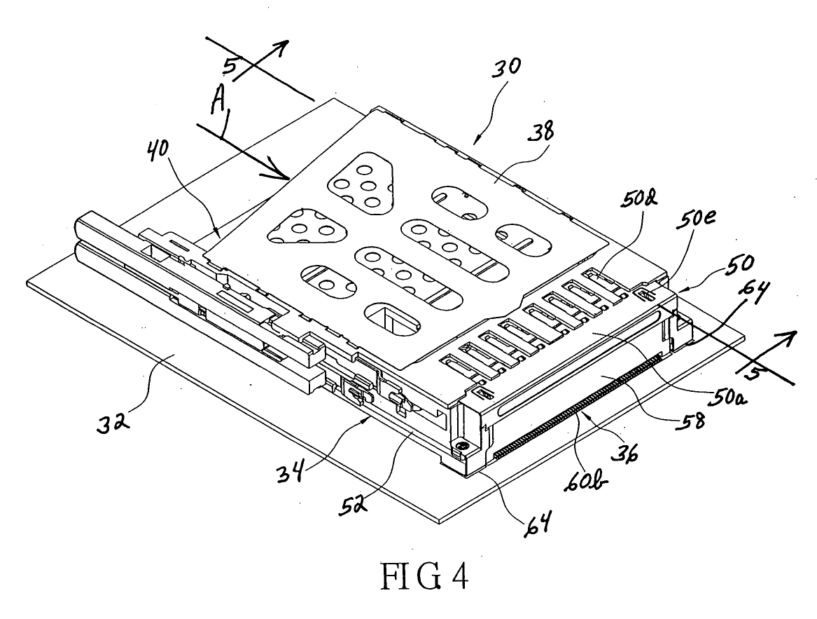

Ground shield cover 50 may be stamped and formed of conductive sheet metal material in a configuration to cover the top and rear of the termination area at the rear of connector 30, particularly covering the top and rear of signal terminals 42. More particularly, the ground shield cover includes an elongated plate portion 50a extending along the rear terminal-mounting section of the housing as indicated at 62 in FIG. 5. Plate portion 50a extends over signal terminals 42. A pair of grounding leg portions 50b depend downwardly from plate portion 50a and terminate in a pair of feet portions 50c which are electrically connected to a pair of ground pads 64 (FIG. 4) on printed circuit board 32. A plurality of fingers 50d project forwardly of plate portion 50a and cover contact portions 46 of signal terminals 42. Finally, ground shield cover 50 includes a pair of flexible ground tabs 50e which are stamped and formed out of plate portion 50a and are bent inwardly as clearly shown in FIG. 5 for engaging ground terminals 44. There are two flexible ground tabs 50e at opposite ends of the elongated plate portion 50a for engaging the two ground terminals 44 at opposite ends of the linear array of signal terminals 42. Therefore, ground shield cover 50 is conductively or electrically coupled between ground terminals 44 and ground pads 64 on the printed circuit board to considerably improve the EMI protection for signal terminals 42.

Ground shield cover 50 is mounted at the rear of housing 34 by a pair of fasteners (not shown) which extends downwardly through holes 66 in the ground shield cover and holes 68 in mounting blocks 54 of the housing. The fasteners securely clamp feet portions 50c of the ground shield cover between the mounting blocks and ground pads 64 on the printed circuit board.

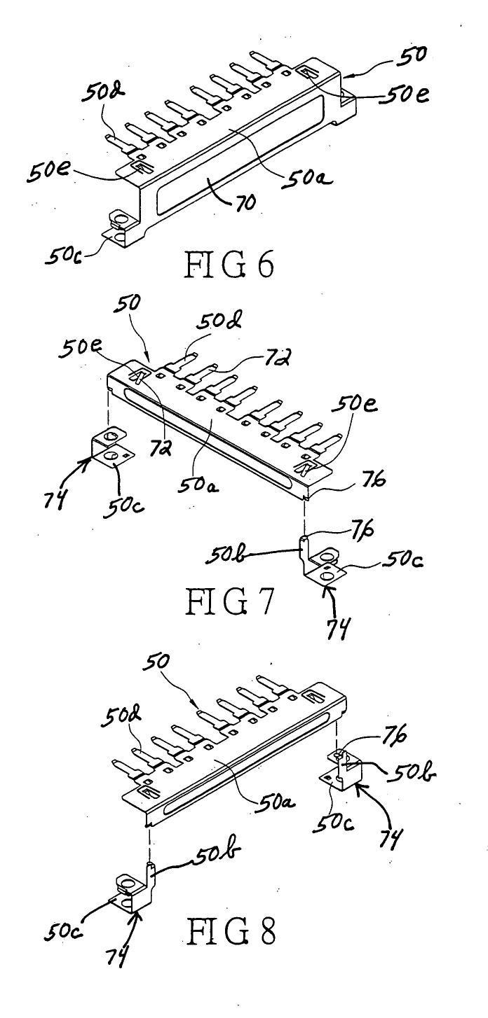

FIG. 6 shows a modified version of ground shield cover 50 wherein plate portion 50a is part of an enlarged L-shaped configuration which includes an enlarged vertical plate portion 70. This configuration provides a more robust structure and also provides somewhat greater EMI protection at the rear termination area of the connector.

It is contemplated that one surface of the flexible ground tabs 50e of ground shield cover 50 be subjected to a gold-plating process so that a gold layer 72 (FIG. 5) is formed on the bottom surfaces of the ground tabs for engaging ground terminals 44. Because the gold layer is in direct contact with the ground terminals, resistance is significantly decreased.

FIGS. 7 and 8 show a second embodiment of the invention wherein leg portions 50b and feet portions 50c of ground shield cover 50 are on separate parts, generally designated 74, of the ground shield cover. The separate parts are connected together at connecting interfaces 76. Before the parts are connected, ground tabs 50e are subjected to a brush-plating process to form gold layers 72. By providing the separate parts, the cost of the electroplating process is decreased.

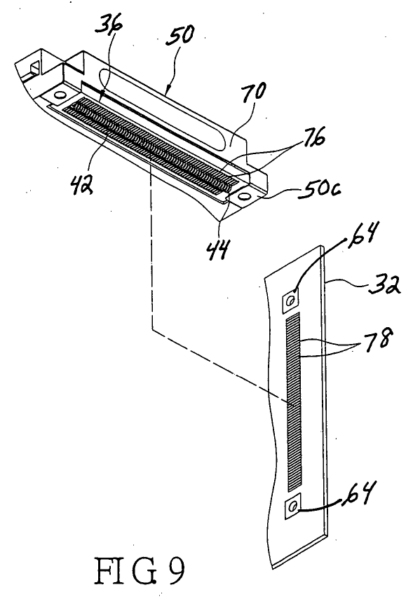

There are various ways that signal terminals 42 and ground terminals 44 can be electrically connected to printed circuit board 32. As stated above, adapter terminals 60 (FIG. 5) can be eliminated and the signal terminals and the ground terminals can be electrically connected directly to the printed circuit board. Accordingly, FIG. 9 shows a third embodiment wherein signal terminals 42 and ground terminals 44 extend all the way down through a plurality of slots 76 in connector portion 36 for direct connection to a plurality of signal circuit traces 78 and ground pads 64 on printed circuit board 32.

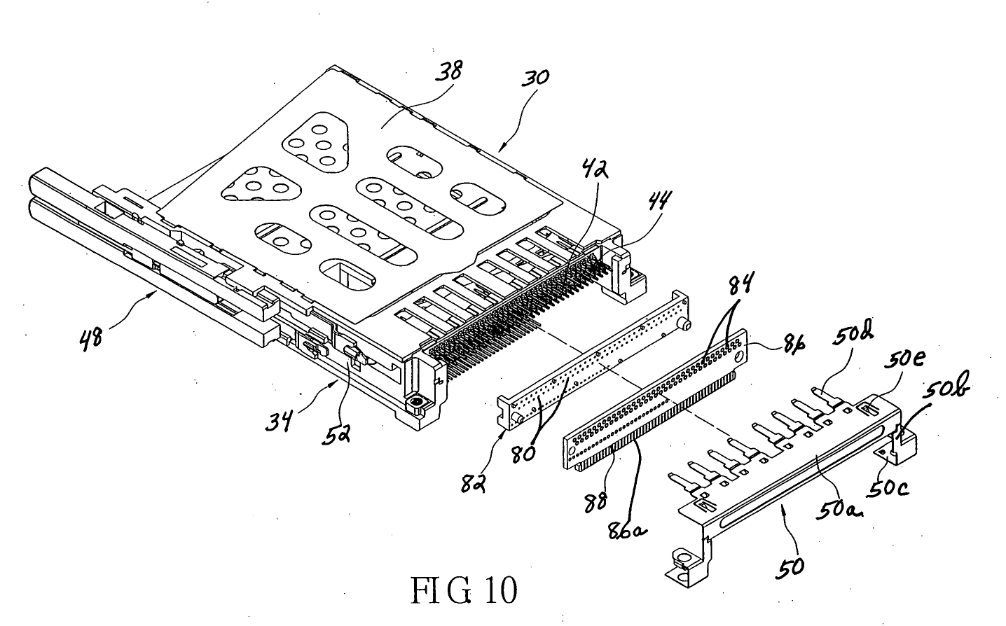

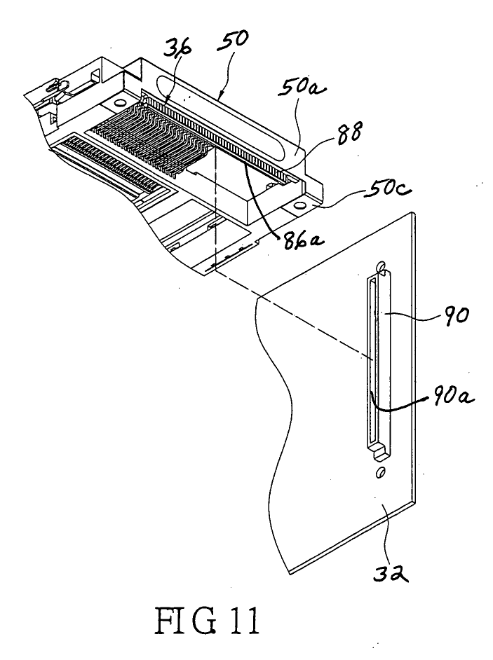

In a fourth embodiment shown in FIGS. 10 and 11, signal terminals 42 and ground terminals 44 have pin portions which project through a plurality of holes 80 in a pin alignment plate 82 and then into a plurality of holes 84 in an auxiliary circuit board 86. The pin portions of the terminals are soldered to appropriate circuit traces on the auxiliary circuit board, and the circuit traces on the auxiliary circuit board include a plurality of terminal portions 88 which engage appropriate terminals within a header connector 90 (FIG. 11) mounted on printed circuit board 32. Specifically, terminal portions 88 are deposited on an edge or tongue 86a of auxiliary circuit board 86, and the tongue is inserted into a slot 90a of the header connector to electrically connect signal terminals 42 and ground terminals 44 to the terminals within the header connector.

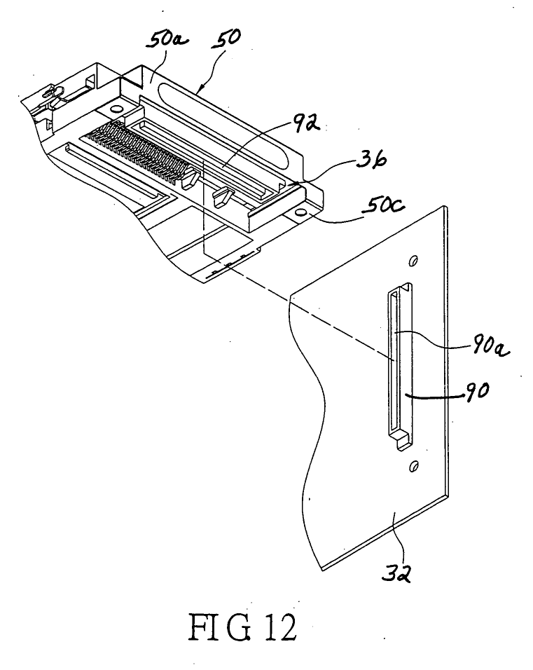

Finally, FIG. 12 shows a fifth embodiment of the invention wherein the signal terminals and the ground terminals are electrically connected to a plurality of terminals in an auxiliary connector, generally designated 92, mounted at the bottom rear area of the connector housing. Auxiliary connector 92, in turn, is mated with header connector 90 on printed circuit board 32 to electrically connect signal terminals 42 and ground terminals 44 to printed circuit board 32.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A memory card connector for mounting on a printed circuit board, comprising:
an insulative housing having a rear terminal-mounting section and which, at least in part, defines a card-receiving space;
a plurality of conductive signal terminals and at least one ground terminal mounted on the rear section of the housing, the terminals being electrically connected to the printed circuit board and including contact portions for engaging appropriate contacts on the memory card when the card is inserted into said space; and
a ground shield cover mounted on the housing at the rear thereof for shielding at least major portions of the signal terminals, the ground shield cover being conductively coupled between the ground terminal and the printed circuit board.

2. The memory card connector of claim 1, including a metal cover mounted across a top of the insulative housing over a substantial portion of the card-receiving space.

3. The memory card connector of claim 1, including a pair of said ground terminals disposed at opposite ends of an array of said signal terminals, with the ground shield cover being conductively coupled between the ground terminals and the printed circuit board.

4. The memory card connector of claim 1 wherein said ground shield cover includes a flexible ground tab in engagement with the ground terminal.

5. The memory card connector of claim 1 wherein said ground shield cover includes a foot portion electrically connected to a ground pad on the printed circuit board.

6. The memory card connector of claim 1 wherein said ground shield cover is stamped and formed of conductive sheet metal material.

7. The memory card connector of claim 1, including a plurality of adapter terminals electrically connected between the signal and ground terminals and the printed circuit board.

8. The memory card connector of claim 1 wherein said ground shield cover includes an elongated plate portion extending along the rear terminal-mounting section of the housing over the signal terminals and having grounding leg portions depending from the plate portion into engagement with ground pads on the printed circuit board.

9. The memory card connector of claim 8 wherein said ground shield cover includes a plurality of fingers projecting from the plate portion over the contact portions of the signal terminals.

10. The memory card connector of claim 1 wherein said housing is sized such that the card-receiving space includes first and second card-receiving slots for receiving a pair of stacked memory cards, and said ground shield cover includes a plate portion extending over the signal terminals and leg portions depending from the plate portion into engagement with ground pads on the printed circuit board.

11. A memory card connector for mounting on a printed circuit board, comprising:
an insulative housing having a rear terminal-mounting section and which, at least in part, defines a card-receiving space;
a metal cover mounted across a top of the insulative housing over a substantial portion of the card-receiving space;
a linear array of signal terminals and a pair of ground terminals at opposite ends of the array of signal terminals all mounted on the rear section of the housing, the terminals being electrically connected to the printed circuit board and including contact portions for engaging appropriate contacts on the memory card when the card is inserted into said space; and
a ground shield cover mounted on the housing at the rear thereof for shielding at least major portions of the signal terminals, the ground shield cover being stamped and formed of conductive sheet metal material and including a pair of flexible ground tabs in engagement with the ground terminals and at least one foot portion electrically connected to a ground pad on the printed circuit board,
whereby the ground shield cover is conductively coupled between the ground terminals and the printed circuit board.

12. The memory card connector of claim 11, including a plurality of adapter terminals electrically connected between the signal and ground terminals and the printed circuit board.

13. The memory card connector of claim 11 wherein said ground shield cover includes an elongated plate portion extending along the rear terminal-mounting section of the housing over the signal terminals and having grounding leg portions depending from the plate portion into engagement with ground pads on the printed circuit board.

14. The memory card connector of claim 13 wherein said ground shield cover includes a plurality of fingers projecting from the plate portion over the contact portions of the signal terminals.

15. The memory card connector of claim 111 wherein said housing is sized such that the card-receiving space includes first and second card-receiving slots for receiving a pair of stacked memory cards, and said ground shield cover includes a plate portion extending over the signal terminals and leg portions depending from the plate portion into engagement with ground pads on the printed circuit board.
